(19) United States
(12) Patent Application Publication
(10) Pub. No.: US 2026/0236188 A1
(43) Pub. Date: Aug. 13, 2026

(54) NON-VOLATILE MEMORY DEVICE BASED ON SEPARATE COMMAND ADDRESS PROTOCOL, OPERATION METHOD OF NON-VOLATILE MEMORY DEVICE, AND STORAGE DEVICE INCLUDING THE NON-VOLATILE MEMORY DEVICE

(71) Applicant: Samsung Electronics Co., Ltd., Suwon-si (KR)

(72) Inventors: Jinbae Bang, Suwon-si (KR); Kiwhan Song, Suwon-si (KR); Wandong Kim, Suwon-si (KR)

(21) Appl. No.: 19/535,791

(22) Filed: Feb. 10, 2026

(30) Foreign Application Priority Data
Feb. 13, 2025 (KR) 10-2025-0018925
Jul. 31, 2025 (KR) 10-2025-0105003

(51) Int. Cl. G06F 3/06

(52) U.S. Cl. CPC G06F 3/0656; G06F 3/0604; G06F 3/067

(57) ABSTRACT

A storage device includes a processor that transmits a command and an address to a non-volatile memory device through a first bus and transmits or receives data to or from the non-volatile memory device through a second bus. The non-volatile memory device senses data from a non-volatile memory cell based on the command and the address, and the processor transmits any one of a command header and an address header and a first address through at least three first pins, in one cycle of a command address clock signal.

### CROSS-REFERENCE TO RELATED APPLICATIONS

This application claims priority under 35 U.S.C. § 119 to Korean Patent Application Nos. 10-2025-0018925 filed on February 13, 2025, and 10-2025-0105003 filed on July 31, 2025, in the Korean Intellectual Property Office, the disclosures of which are incorporated by reference herein in their entireties.

### BACKGROUND

With the development of technologies, there is a growing demand for an increase in a data input/output speed of a flash memory device which is a non-volatile memory. In particular, it is difficult to sufficiently meet the high-speed demand by using an interfacing manner of a storage device which inputs a command, an address, and data through a conventional input/output (I/O) pin. Accordingly, a method of separating a command address pin from a data pin is being attempted in the storage device including the non-volatile memory device.

In the interfacing method of the non-volatile memory device in which a command address pin and a data pin are separated, there is required a method of further improving the input/output efficiency.

### SUMMARY

Implementations of the present disclosure provide a non-volatile memory device which uses a communication interface based on a separate command address protocol and improves the efficiency of input/output between a processor and the non-volatile memory device, an operation method of the non-volatile memory device, and a storage device including the non-volatile memory device.

Implementations of the present disclosure provide a non-volatile memory device which uses a communication interface based on a separate command address protocol and improves the efficiency of input/output of a command and an address between a processor and the non-volatile memory device, an operation method of the non-volatile memory device, and a storage device including the non-volatile memory device.

According to some implementations, a storage device may include a processor that transmits a command and an address to a non-volatile memory device through a first bus and transmits or receives data to or from the non-volatile memory device through a second bus. The non-volatile memory device may sense data from a non-volatile memory cell based on the command and the address, and the processor may transmit any one of a command header and an address header and a first address through at least three first pins, in one cycle of a command address clock signal.

According to some implementations, a non-volatile memory device includes a memory cell array that includes non-volatile memory cells, an input/output circuit that receives a command and an address through a first bus and transmits read data through a second bus or receive programming data through the second bus, and a control logic circuit that decodes the command. The input/output circuit may receive any one of a command header and an address header and a first address through at least three first pins, in one cycle of a command address clock signal.

According to some implementations, an operation method of a non-volatile memory device may include receiving, at an input/output circuit, a command address packet in a first cycle and a second cycle of a command address clock signal, which are consecutive, through at least three pins, decoding, at a control logic circuit, any one of a command header and an address header and a first address from a first bit signal received in the first cycle, and decoding, at the control logic circuit, a command based on the command header or a second address based on the address header, from a second bit signal received in the second cycle.

### BRIEF DESCRIPTION OF THE DRAWINGS

The above and other objects and features of the present disclosure will become apparent by describing in detail implementations thereof with reference to the accompanying drawings.

FIG. 1 is a block diagram illustrating a storage device according to some implementations of the present disclosure.

FIG. 2 is a timing diagram illustrating a structure of a command address packet and a reception timing according to some implementations of the present disclosure.

FIG. 3 is a timing diagram illustrating a structure of a command address packet and a reception timing according to the related art.

FIG. 4 is a diagram describing a header of a command address packet according to a type of a command address packet of the related art.

FIG. 5 is a block diagram illustrating a configuration of a processor according to some implementations of the present disclosure.

FIG. 6 is a diagram illustrating a configuration of a storage device including a plurality of non-volatile memory devices according to some implementations of the present disclosure.

FIG. 7 is a diagram illustrating a memory block of a three-dimensional V-NAND structure applicable to a storage device according to some implementations of the present disclosure.

FIG. 8 is a block diagram describing a configuration of a non-volatile memory device according to some implementations of the present disclosure.

FIG. 9 is a diagram describing a configuration of a command address packet according to some implementations of the present disclosure.

FIG. 10 is a diagram describing a header of a command address packet according to the implementations of FIG. 9.

FIG. 11 is a diagram describing read sequences according to the implementations of FIG. 9.

FIG. 12 is a diagram describing a configuration of a command address packet according to some implementations of the present disclosure.

FIGS. 13 and 14 are diagrams describing a header of a command address packet according to the implementations of FIG. 12.

FIG. 15 is a diagram describing read sequences according to the implementations of FIG. 12.

FIG. 16 is a diagram describing a configuration of a command address packet according to some implementations of the present disclosure.

FIG. 17 is a diagram describing a header of a command address packet according to the implementations of FIG. 16.

FIG. 18 is a diagram describing read sequences according to the implementations of FIG. 16.

FIG. 19 is a diagram describing a configuration of a command address packet according to some implementations of the present disclosure.

FIGS. 20 and 22 are diagrams describing a header of a command address packet according to the implementations of FIG. 19.

FIGS. 23 and 24 are diagrams describing read sequences according to the implementations of FIG. 12.

FIG. 25 is a flowchart describing an operating method of a memory device according to some implementations of the present disclosure.

### DETAILED DESCRIPTION

Below, implementations of the present disclosure will be described in detail and clearly to such an extent that an ordinary one in the art easily carries out the present disclosure.

In the specification, the writing of data may be used as a meaning the same as or similar to storing and programming data. In the specification, the readout of data may be used as a meaning the same as or identical to reading data.

In the specification, for example, implementations will be described under the assumption that a non-volatile memory chip includes one logical unit number (hereinafter, referred to as an “LUN”). That is, in the specification, the LUN is used as a meaning the same as or similar to a chip. However, in the specification, implementations do not exclude a non-volatile memory chip including a plurality of LUNs.

In the specification, a command packet may mean a packet, whose body includes a command, from among command address packets which are transmitted to a command address bus. An address packet may mean a packet, whose body includes an address, from among the command address packets which are transmitted to the command address bus.

Implementations of the present disclosure described herein relate to a semiconductor memory device, and more particularly, relate to a non-volatile memory device which communicates with a host based on a separate command address (SCA) protocol and improves the input/output efficiency of a command and an address, an operation method of the non-volatile memory device, and a storage device including the non-volatile memory device.

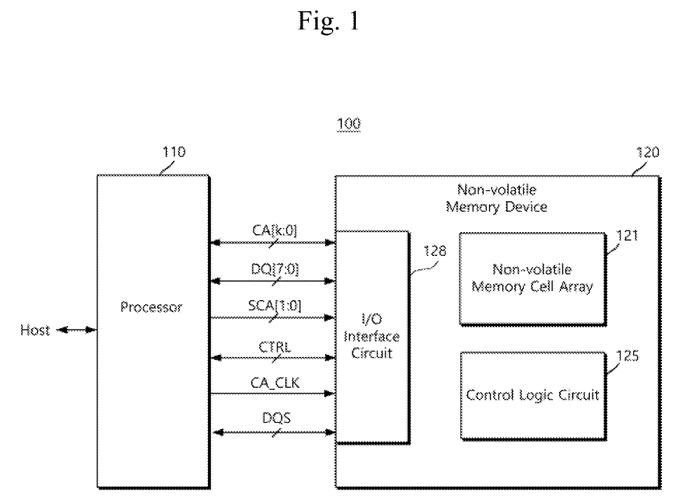

FIG. 1 is a block diagram illustrating a storage device 100 according to some implementations of the present disclosure.

Referring to FIG. 1, the storage device 100 may include a processor 110 and a non-volatile memory device 120.

The processor 110 may control the non-volatile memory device 120 to perform an input/output request of a host. The processor 110 may be configured to control the non-volatile memory device 120 under control of the host or depending on a command from the host. The input/output request may include a write operation, a read operation, and/or an erase operation for user data, which the host requests from the storage device 100. In the specification, the processor 110 may be used as a meaning the same as or similar to a storage controller, a memory controller, etc.

For example, depending on the request of the host, the processor 110 may write data in the non-volatile memory device 120 or may read data stored in the non-volatile memory device 120. For the communication with the non-volatile memory device 120, the processor 110 may provide the non-volatile memory device 120 with control signals CTRL, a data signal DQ, a command address signal CA, a command address clock signal CA_CLK, and a data strobe signal DQS. According to some implementations, each signal may be transmitted unidirectionally or bidirectionally.

The processor 110 may transmit the command address signal CA to the non-volatile memory device 120 through a first bus and may exchange the data signal DQ with the non-volatile memory device 120 through a second bus.

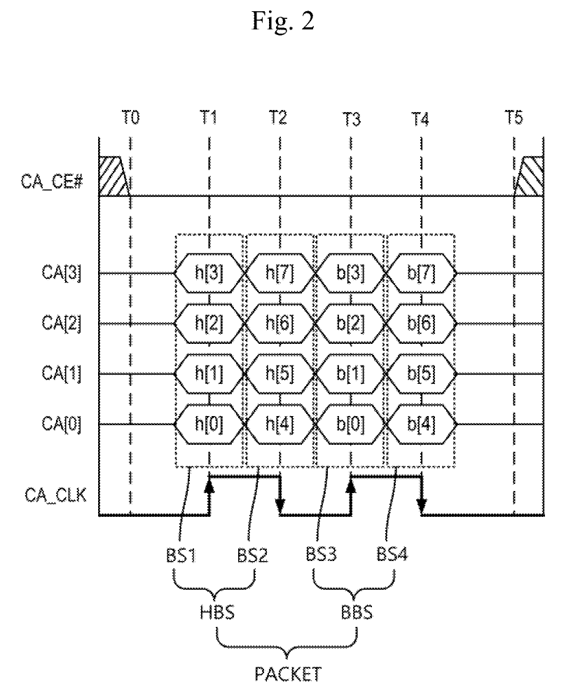

The processor 110 may transmit the command address signal CA and the data signal DQ to the non-volatile memory device 120 in the form of a packet. For example, as described with reference to FIG. 2, the processor 110 may transmit, to the non-volatile memory device 120, the command address signal CA and the data signal DQ in the form of a packet including a header and a body.

In addition to the signals illustrated in FIG. 1, the processor 110 may transmit various signals to the non-volatile memory device 120.

In addition to the command address signal CA and the data signal DQ, the non-volatile memory device 120 may transmit and/or receive various signals.

For example, referring to FIG. 1, the non-volatile memory device 120 may receive an SCA signal SCA, the control signals CTRL, the command address clock signal CA_CLK, and the data strobe signal DQS.

Each of the buses between the processor 110 and the non-volatile memory device 120 may be implemented by using at least one pin. For example, the second bus transferring the data signal DQ may be implemented based on eight or more pins.

The non-volatile memory device 120 may store data received through the second bus from the processor 110 in a memory cell of a non-volatile memory cell array 121. Alternatively, the non-volatile memory device 120 may sense data stored in a memory cell and may transmit the sensed data to the processor 110 through the second bus.

The non-volatile memory device 120 may be provided as a storage medium of the storage device 100. For example, the non-volatile memory device 120 may be provided as a NAND-type flash memory having a high-capacity storage capability.

The non-volatile memory device 120 may include a plurality of non-volatile memory chips. For example, the non-volatile memory device 120 may include a plurality of flash memory chips.

The non-volatile memory device 120 may include flash memory devices of a two- dimensional (2D) structure or a three-dimensional (3D) structure. The flash memory device may include different kinds of non-volatile memories such as a NAND flash memory, a vertical NAND (V-NAND) flash memory, a NOR flash memory, a magnetic memory (MRAM), a phase-change memory (PRAM), a ferroelectric random access memory (FRAM), a spin transfer torque random access memory (STT-RAM), and/or a resistive RAM (RRAM).

When the non-volatile memory device 120 includes a plurality of non-volatile memory chips, the non-volatile memory chips may be connected to the processor 110 in units of channels. A plurality of non-volatile memory chips which communicate through the same data bus may be connected to one channel. The non-volatile memory device 120 may communicate with the processor 110 in a channel/way interleaving manner.

According to some implementations, the storage device 100 may include a buffer memory device. The buffer memory device may be used as a data buffer for data exchange between the storage device 100 and the host. Write data provided from the host or data read from the non-volatile memory device 120 may be temporarily stored in the buffer memory device. In association with the read request of the host, when data present in the non-volatile memory device 120 are cached in the buffer memory device, the buffer memory device may support a cache function of providing the cached data directly to the host. The buffer memory device may be implemented with a synchronous DRAM such that the storage device 100 used as a high-capacity auxiliary storage device provides sufficient buffering. However, the buffer memory device is not limited to this example.

When the non-volatile memory device 120 includes a plurality of non-volatile memory chips, some of the non-volatile memory chips may share a bus.

For example, each of some non-volatile memory chips may receive the command address signal CA through the same command address lines. In some non-volatile memory chips, pads electrically connected to the command address line may be electrically connected to each other. Likewise, some non-volatile memory chips may share different buses.

The non-volatile memory device 120 may include the non-volatile memory cell array 121, a control logic circuit 125, and an input/output (I/O) interface circuit 128.

The memory cell array 121 may include a plurality of memory blocks, and each of the memory blocks may be a plurality of memory cells.

The control logic circuit 125 may overall control various kinds of operations of the non-volatile memory device 120. For example, in response to the command and the address received from the processor 110, the control logic circuit 125 may direct the writing of data in memory cells of the memory cell array 121 or may direct the reading of data from the memory cells.

The input/output interface circuit 128 may sample the received data signal DQ based on the data strobe signal DQS and may transmit the sampled data to a page buffer circuit temporarily before the sampled data are programmed in the non-volatile memory cell array 121.

The processor 110 of the storage device 100 according to some implementations of the present disclosure may transmit a command address packet CA[k:0] (k being a natural number of 3 or more) to the non-volatile memory device 120 through at least three pins. For example, the processor 110 may transmit the command address signal CA to the non-volatile memory device 120 through four pins in the form of a packet.

The processor 110 may transmit the command address signal CA to the non-volatile memory device 120 based on the command address clock signal CA_CLK.

In the same single cycle of the command address clock signal CA_CLK, the processor 110 may transmit any one of a command header and an address header and a first address to the non-volatile memory device 120.

For example, in a first cycle of the command address clock signal CA_CLK, the processor 110 may transmit any one of the command header and the address header and the first address to the non-volatile memory device 120.

For example, in the first cycle of the command address clock signal CA_CLK, the processor 110 may transmit the command header and a chip address to the non-volatile memory device 120.

For example, in the first cycle of the command address clock signal CA_CLK, the processor 110 may transmit the command header and a column address to the non-volatile memory device 120.

For example, in the first cycle of the command address clock signal CA_CLK, the processor 110 may transmit the address header and the column address to the non-volatile memory device 120.

In the same single cycle of the command address clock signal CA_CLK, the non-volatile memory device 120 may receive any one of the command header and the address header and the first address from the command address signal CA.

In some implementations, the processor 110 may transmit the command address signal CA through two pins in a first mode and may transmit the command address signal CA through at least three pins in a second mode. To distinguish the first mode and the second mode, the processor 110 may transmit an SCA signal SCA[1:0] to the non-volatile memory device 120. The non-volatile memory device 120 may receive and decode the command address signal CA in any one of the first mode or the second mode, based on the SCA signal SCA[1:0].

For example, the SCA signal SCA[1:0] may be a signal for identifying the generation of the separate command address (SCA) protocol. The first mode may refer to a mode in which a command address signal is transmitted through two pins based on the first generation separate command address protocol. The second mode may refer to a mode in which a command address signal is transmitted through at least three pins based on the second generation separate command address protocol.

The non-volatile memory device 120 according to some implementations of the present disclosure may receive the command address signal CA from the processor 110 through at least three pins and decoding a plurality of information from one command address packet, and thus, the efficiency of transmission of a command and an address may be improved.

For example, the processor 110 may transmit the command and the chip address by using one command packet. The processor 110 may transmit the command and the column address by using one command packet. The processor 110 may transmit the column address and a row address by using one address packet.

Accordingly, as a plurality of information is transmitted to the non-volatile memory device 120 from the processor 110 through one command address packet, the efficiency of transmission of a command and an address may be improved.

FIG. 2 is a timing diagram illustrating a structure of a command address packet and a reception timing according to some implementations of the present disclosure. An example in which a command address packet is transmitted through four pins will be described with reference to FIG. 2, but the command address packet of the present disclosure may be transmitted through at least three or more pins without being limited to the four pins. Likewise, in the specification, other implementations will be described based on a command address packet which is transmitted through four pins, but the command address packet of the present disclosure may be transmitted through at least three or more pins without being limited to the four pins.

A structure of the command address packet and a reception timing according to some implementations of the present disclosure will be described with reference to FIGS. 1 and 2. The command address packet of FIG. 2 may be transmitted from the processor 110 of FIG. 1 to the non-volatile memory device 120.

Referring to FIG. 2, the processor 110 may transmit a header bit signal HBS in the first cycle of the command address clock signal CA_CLK and may transmit a body bit signal BBS in the second cycle of the command address clock signal CA_CLK.

The header bit signal HBS may include a first bit signal BS1 and a second bit signal BS2. The body bit signal BBS may include a third bit signal BS3 and a fourth bit signal BS4.

The processor 110 may transmit the first bit signal BS1 at T1, that is, at the rising edge of the first cycle of the command address clock signal CA_CLK and may transmit the second bit signal BS2 at T2, that is, at the falling edge of the first cycle of the command address clock signal CA_CLK. The processor 110 may transmit the third bit signal BS3 at T3, that is, at the rising edge of the second cycle of the command address clock signal CA_CLK and may transmit the fourth bit signal BS4 at T4, that is, at the falling edge of the second cycle of the command address clock signal CA_CLK.

The processor 110 may transmit four bits h[3:0] as the first bit signal BS1 through the four command address pins. The processor 110 may transmit four bits h[7:4] as the second bit signal BS2 through the four command address pins. The processor 110 may transmit four bits b[3:0] as the third bit signal BS3 through the four command address pins. The processor 110 may transmit four bits b[7:4] as the fourth bit signal BS4 through the four command address pins.

The header bit signal HBS may include a header and a first address.

In some implementations, the header may include information defining types of the command address packet, such as a command header and an address header. According to some implementations, the header included in the header bit signal HBS of the present disclosure may be based on the types of the command address packet defined by the JEDEC (Joint Electron Device Engineering Council) standard or a portion thereof may be based on types of the command address packet newly defined according to some implementations of the present disclosure.

In some implementations, the first address may include any one of the chip address and the column address.

The body bit signal BBS may include any one of the command and the second address which are transmitted through the command address packet.

In some implementations, the body bit signal BBS may include any one of the commands defined by the JEDEC standard. The body bit signal BBS may include any one of the chip address and the row address as the second address depending on a type of the command address packet.

In some implementations, in the header bit signal HBS, information included in the first bit signal BS1 may be distinguished from information included in the second bit signal BS2. For example, the non-volatile memory device 120 may decode first information in the first bit signal BS1 and may decode second information in the second bit signal BS2.

In some implementations, in the header bit signal HBS, the first bit signal BS1 and the second bit signal BS2 may include pieces of merged information. For example, the non-volatile memory device 120 may decode the first information and the second information by decoding the first bit signal BS1 and the second bit signal BS2 together.

The storage device 100 according to some implementations of the present disclosure may improve a transmission speed of the command address packet by transmitting the command address packet within two cycles of the command address clock signal CA_CLK between the processor 110 and the non-volatile memory device 120.

The storage device 100 according to some implementations of the present disclosure may reduce the number of command address packets to be transmitted to the non-volatile memory device 120 by transmitting the header and the first address within the same single cycle of the command address clock signal CA_CLK between the processor 110 and the non-volatile memory device 120. As a result, the efficiency of transmission of the command and the address may be improved.

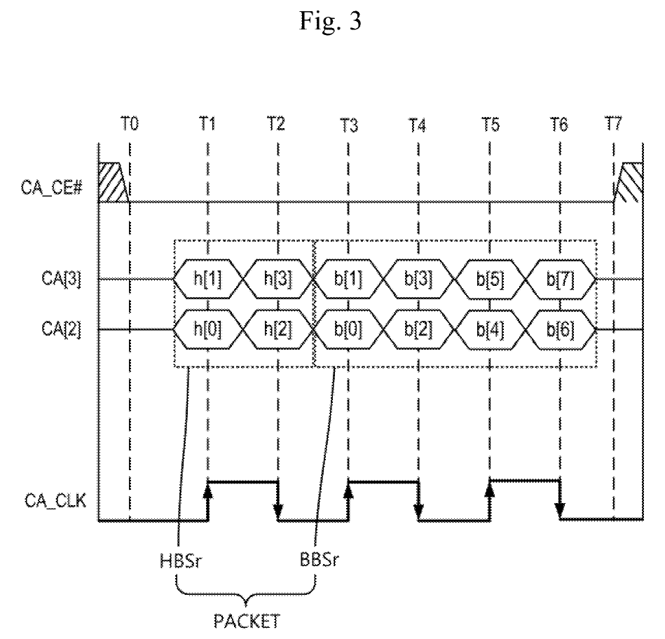

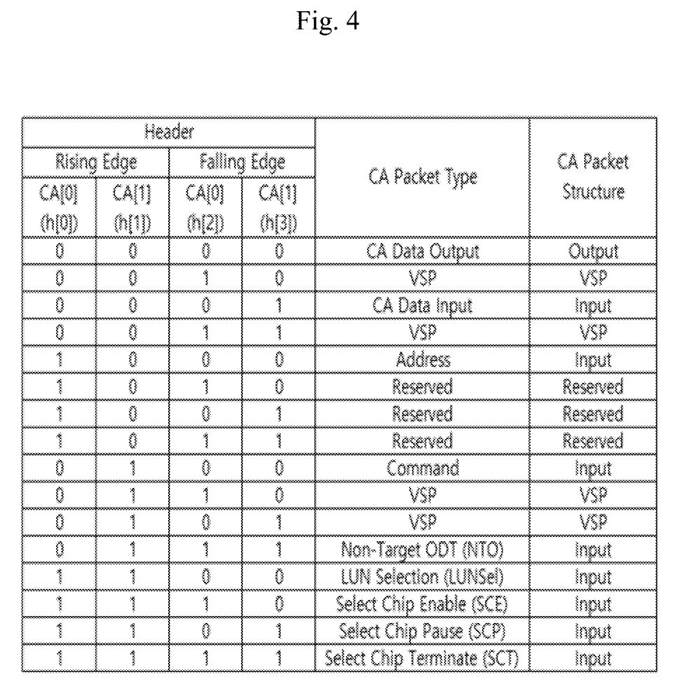

FIG. 3 is a timing diagram illustrating a structure of a command address packet and a reception timing according to the related art, and FIG. 4 is a diagram describing a header of a command address packet corresponding to a type of a command address packet of the related art.

Referring to FIG. 3, unlike the implementations of the present disclosure illustrated in FIG. 2, the command address packet of the related art is transmitted through two command address pins during three cycles of the command address clock signal CA_CLK.

Referring to FIG. 4, types of the command address packet transfer only one piece of information. For example, except for a vendor specific packet VSP, the address packet among the types of the command address packet transmits one address by using one packet.

Also, the command address packet of the related art includes only the header in a header bit signal HBSr of FIG. 3. That is, the header bit signal HBSr of the related art does not include any other information except for the header indicating the type of the command address packet.

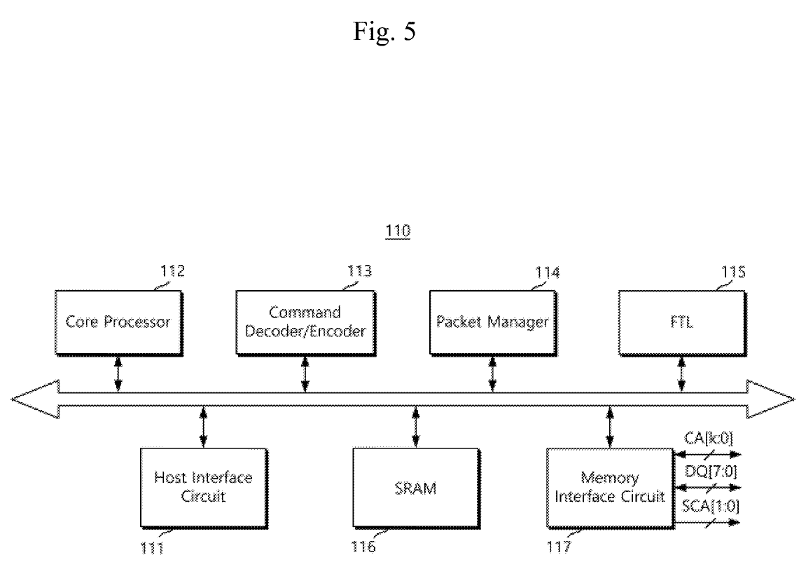

FIG. 5 is a block diagram illustrating a configuration of the processor 110 according to some implementations of the present disclosure. The processor 110 to be described with reference to FIG. 4 may correspond to the processor 110 of FIG. 1.

The processor 110 may include a host interface circuit 111, a core processor 112, a command decoder/encoder 113, a packet manager 114, a flash translation layer (FTL) 115, an SRAM 116, and a memory interface circuit 117.

The processor 110 may communicate with the host through the host interface circuit 111. The host interface circuit 111 may be implemented with various interface manners such as advanced technology attachment (ATA), serial ATA (SATA), external SATA (e-SATA), small computer small interface (SCSI), serial attached SCSI (SAS), peripheral component interconnection (PCI), PCI express (PCIe), IEEE 1394, universal serial bus (USB), NVMe, and CXL.

The core processor 112 may be implemented with a circuit, logic, a code, or a combination thereof. The core processor 112 controls all operations of the storage device 100 including the processor 110. When the storage device 100 is driven, the core processor 112 may load firmware stored in a read only memory (ROM) to a memory device and may perform all the operations of the processor 110. The core processor 112 may load the flash translation layer 115 to the working memory; based on an address translation result of the flash translation layer 115, the core processor 112 may program data in the non-volatile memory device 120 and/or may read data from the non-volatile memory device 120.

The command decoder/encoder 113 may decode a command parsed from a packet received from the host, based on the protocol of the interface agreed upon with the host. For example, the command decoder/encoder 113 may decode an opcode of a command which is based on a specific protocol and may identify a program command, an erase command, a read command, and/or a secure erase command. The core processor 112 may perform requests of the host depending on the decoded commands. In some implementations, the command decoder/encoder 113 may be implemented as an independent circuit and/or part of firmware.

The flash translation layer 115 may perform various functions (or operations) such as address mapping, wear-leveling, and garbage collection.

The address mapping operation refers to an operation of translating a logical address received from the host into a physical address to be actually used to program data in the non-volatile memory device 120 of FIG. 1. For example, a logical block address (LBA) of user data which are requested by the host to be programmed may be translated into a physical address of the non-volatile memory device 120 of FIG. 1 by using the flash translation layer 115. In some implementations, the physical address may be a physical page number (PPN). In some implementations, an address mapping table which the flash translation layer 115 manages may store a mapping relationship between a logical page number (LPN) and a physical page number. In some implementations, each of logical page numbers LPN may correspond to a plurality of logical block addresses LBA.

Wear-leveling is a technology for allowing blocks of the non-volatile memory device 120 of FIG. 1 to be used uniformly such that excessive degradation of a specific memory block is prevented and may be implemented, for example, through a firmware technology for balancing erase counts of physical blocks. Garbage collection refers to a technology for securing an available capacity of the non-volatile memory device 120 of FIG. 1 through a way to copy valid data of a memory block to a new memory block and to then erase the existing memory block.

The SRAM 116 may store temporary data, temporary variables, etc. for performing the operations of the core processor 112.

The memory interface circuit 117 provides an interface between the processor 110 and the non-volatile memory device 120. For example, data processed by the core processor 112 and/or the packet manager 114 may be written in the non-volatile memory device 120 through the memory interface circuit 117. For another example, data stored in the non-volatile memory device 120 of FIG. 1 may be output to the processor 110 through the memory interface circuit 117.

The memory interface circuit 117 may communicate with the non-volatile memory device 120 by using the separate command address (SCA) protocol. That is, the memory interface circuit 117 may communicate with the non-volatile memory device 120 of FIG. 1 by using the first bus transferring the command address signal CA and the second bus transferring the data signal DQ.

According to some implementations of the present disclosure, the memory interface circuit 117 may transmit the command address signal CA through two pins in the first mode or may transmit the command address signal CA through at least three pins in the second mode.

The command decoder/encoder 113 may encode the command address packets in different manners in the first mode and the second mode. For example, in the second mode where the command address signal CA is transmitted through at least three pins, the command decoder/encoder 113 may encode the header bit signal HBS of FIG. 2 based on the header and the first address. The packet manager 114 may generate the command address packet based on the header bit signal HBS including the header and the first address and the body bit signal BBS in the second mode. In the second mode, the memory interface circuit 117 may transmit the command address packet to the non-volatile memory device 120 of FIG. 1 during two cycles of the command address clock signal CA_CLK.

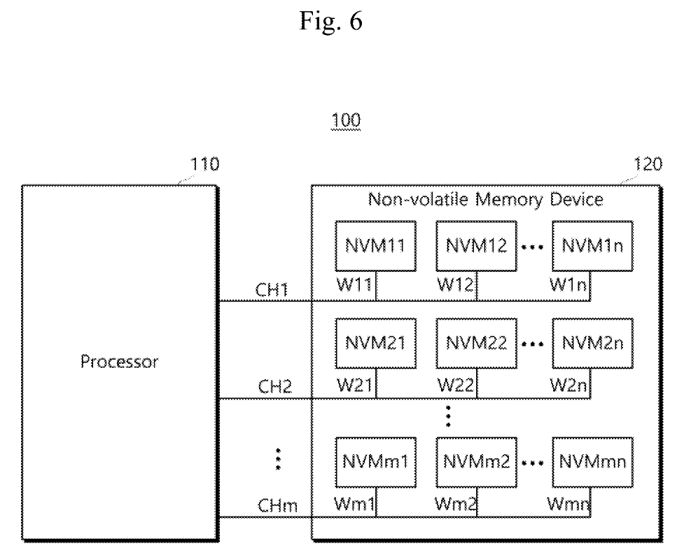

FIG. 6 is a diagram illustrating a configuration of the storage device 100 including a plurality of non-volatile memory devices according to some implementations of the present disclosure.

The processor 110 may perform an input/output on a plurality of non-volatile memory devices NVM11 to NVMmn through a plurality of channels CH1 to CHm. The non-volatile memory device 120 and the processor 110 may be connected through the plurality of channels CH1 to CHm. In some implementations, the processor 110 may include a plurality of controller modules for respective channels. Each of the plurality of channels CH1 to CHm may include the buses described with reference to FIG. 1.

The processor 110 may control a non-volatile memory device (e.g., one of NVM11 to NVMmn) connected to any one of the plurality of channels CH1 to CHm through ways W11, W12, … W1n, … Wm1, … Wmn.

The processor 110 may exchange signals with the non-volatile memory device 120 through the plurality of channels CH1 to CHm. The processor 110 may transmit the command address packet of FIG. 2 to the plurality of non-volatile memory devices NVM11 to NVMmn through the plurality of channels CH1 to CHm.

The non-volatile memory device 120 may include the plurality of non-volatile memory devices NVM11 to NVMmn. Each of the non-volatile memory devices NVM11 to NVMmn may be a non-volatile memory package. In some implementations, each of the non-volatile memory devices NVM11 to NVMmn may include a plurality of chips, but the present disclosure is not limited thereto.

The non-volatile memory device 120 may receive a first command for an interleaving operation between a plurality of non-volatile memory devices connected to the same channel.

For example, to read data from each of the non-volatile memory devices NVM11, NVM12, …, NVM1n connected to the first channel CH1, the processor 110 may transmit the first command to each of the non-volatile memory devices NVM11, NVM12, …, NVM1n. The processor 110 may transmit the read command to each of the non-volatile memory devices NVM11, NVM12, …, NVM1n and may transmit the first command to each of the non-volatile memory devices NVM11, NVM12, …, NVM1n. Each of the non-volatile memory devices NVM11, NVM12, …, NVM1n may operate in the interleaving manner in response to the first command.

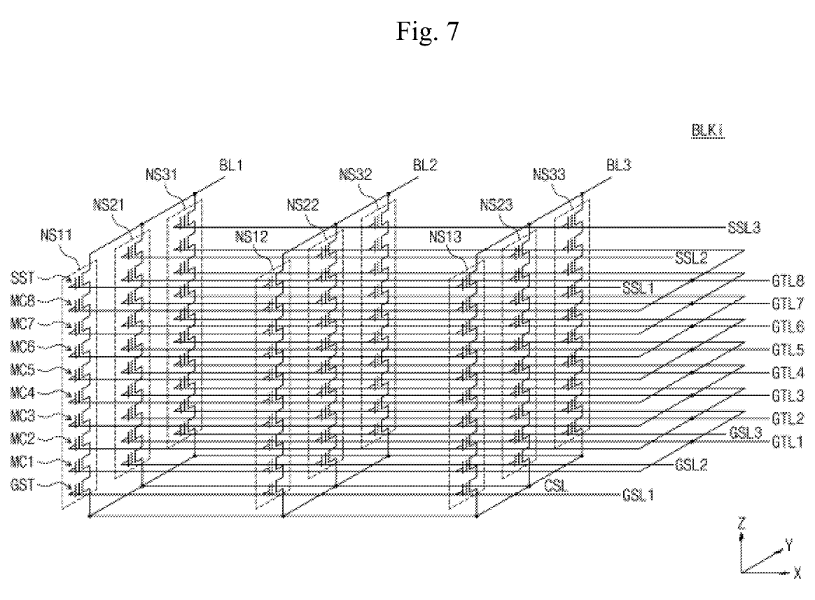

FIG. 7 is a diagram illustrating a memory block of a three-dimensional V-NAND structure applicable to a storage device according to some implementations of the present disclosure. A memory block BLKi of FIG. 7 may be one of the memory blocks included in the memory cell array 121 of the non-volatile memory device 120 of FIG. 1.

When the non-volatile memory device 120 of the storage device 100 of FIG. 1 is implemented with a flash memory of a 3D V-NAND type, each of the plurality of memory blocks constituting the non-volatile memory device 120 may be expressed by an equivalent circuit illustrated in FIG. 6.

The memory block BLKi illustrated in FIG. 7 indicates a three-dimensional memory block formed on a substrate in a three-dimensional structure. For example, a plurality of memory NAND strings included in the memory block BLKi may be formed in a direction perpendicular to the substrate.

Referring to FIG. 7, the memory block BLKi may include a plurality of memory NAND strings NS11 to NS33 connected between bit lines BL1, BL2, and BL3 and a common source line CSL. Each of the plurality of memory NAND strings NS11 to NS33 may include a string selection transistor SST, a plurality of memory cells MC1, MC2, ..., MC8, and a ground selection transistor GST. Some implementations in which each of the plurality of memory NAND strings NS11 to NS33 includes eight memory cells MC1, MC2, ..., MC8 is illustrated in FIG. 7, but some implementations of the present disclosure is not necessarily limited thereto.

The string selection transistor SST may be connected to a corresponding one of string selection lines SSL1, SSL2, and SSL3. The plurality of memory cells MC1, MC2, ..., MC8 may be respectively connected to gate lines GTL1, GTL2, ..., GTL8. The gate lines GTL1, GTL2, ..., GTL8 may correspond to word lines, and at least one of the gate lines GTL1, GTL2, ..., GTL8 may correspond to a dummy word line. The ground selection transistor GST may be connected to a corresponding one of ground selection lines GSL1, GSL2, and GSL3. The string selection transistor SST may be connected to a corresponding bit line among the bit lines BL1, BL2, and BL3, and the ground selection transistor GST may be connected to the common source line CSL.

Word lines (e.g., WL1) at the same height may be connected in common, the ground selection lines GSL1, GSL2, and GSL3 may be separated from each other, and the string selection lines SSL1, SSL2, and SSL3 may be separated from each other. An example in which the memory block BLKi is connected to eight gate lines GTL1, GTL2, ..., GTL8 and three bit lines BL1, BL2, and BL3 is illustrated in FIG. 7, but implementations of the present disclosure is not limited thereto.

The bit density of the memory block BLKi may vary depending on the number of bits which each of the memory cells included in the memory block BLKi stores.

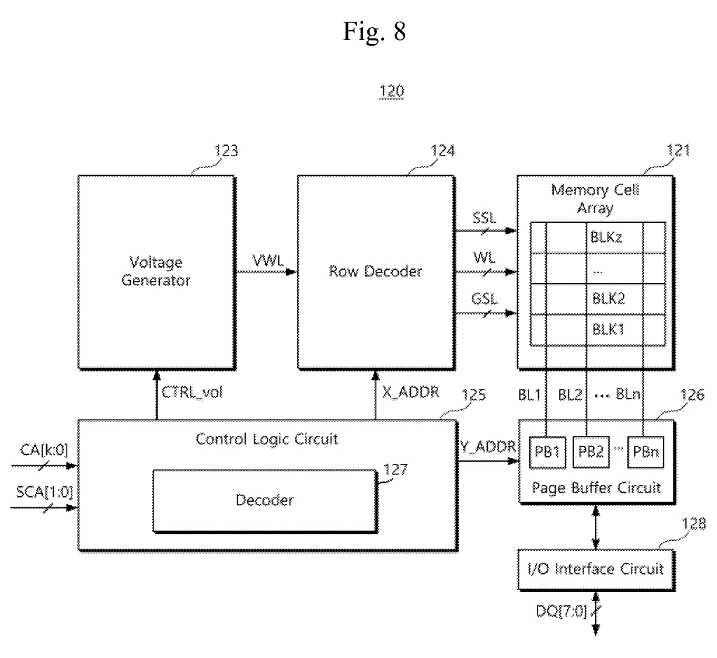

FIG. 8 is a block diagram describing a configuration of the non-volatile memory device 120 according to some implementations of the present disclosure. The non-volatile memory device 120 to be described with reference to FIG. 8 may correspond to the non-volatile memory device 120 of FIG. 1. Additional description which is the same as the description given with reference to FIG. 1 will be omitted to avoid redundancy.

Referring to FIG. 8, the non-volatile memory device 120 may include the memory cell array 121, a voltage generator 123, a row decoder 124, the control logic circuit 125, a page buffer circuit 126, and the input/output interface circuit 128.

The control logic circuit 125 may overall control various kinds of operations of the non-volatile memory device 120. The control logic circuit 125 may output various kinds of control signals in response to the command address signal CA. For example, the control signals may include a voltage control signal CTRL_vol, a row address X_ADDR, and a column address Y_ADDR.

The memory cell array 121 may include a plurality of memory blocks BLK1 to BLKz (z being a positive integer), and each of the plurality of memory blocks BLK1 to BLKz may include a plurality of memory cells. The memory blocks BLK1 to BLKz may be connected to the page buffer circuit 126 through bit lines BL1 to BLn and may be connected to the row decoder 124 through word lines WL, string selection lines SSL, and ground selection lines GSL.

The page buffer circuit 126 may include a plurality of page buffers PB1 to PBn (n being an integer of 3 or more), and the plurality of page buffers PB1 to PBn may be respectively connected to memory cells included in each of the plurality of memory blocks BLK1 to BLKz through the plurality of bit lines BL1 to BLn. Each of the plurality of page buffers PB1 to PBn may include a latch. The page buffer circuit 126 may select at least one of the bit lines BL1 to BLn in response to the column address Y_ADDR. The page buffer circuit 126 may operate as a write driver or a sense amplifier depending on an operation mode. For example, in the program operation, the page buffer circuit 126 may apply a bit line voltage corresponding to the data “DATA” to be programmed to a selected bit line. In the read operation, the page buffer circuit 126 may sense a current or a voltage of the selected bit line to read data stored in a memory cell. The plurality of page buffers PB1 to PBn of the page buffer circuit 126 may sense data stored in memory cells through the plurality of bit lines BL1 to BLn and may temporarily store the sensed data as sensing data.

The voltage generator 123 may generate various kinds of voltages (e.g. a word-line voltage VWL) for performing the program operation, the read operation, the erase operation, etc. based on the voltage control signal CTRL_vol.

In response to the row address X_ADDR, the row decoder 124 may select one of the plurality of word lines WL and may select one of the plurality of string selection lines SSL.

The control logic circuit 125 according to some implementations of the present disclosure may include a decoder 127.

In some implementations, the decoder 127 may operate in any one of the first mode and the second mode based on the SCA signal SCA. For example, the decoder 127 may decode the command address signal CA in different manners in the first mode and the second mode.

For example, the decoder 127 may decode the header from the header bit signal HBS of the command address signal CA in the first mode. The decoder 127 may decode the header and the first address from the header bit signal HBS of the command address signal CA of FIG. 2 in the second mode.

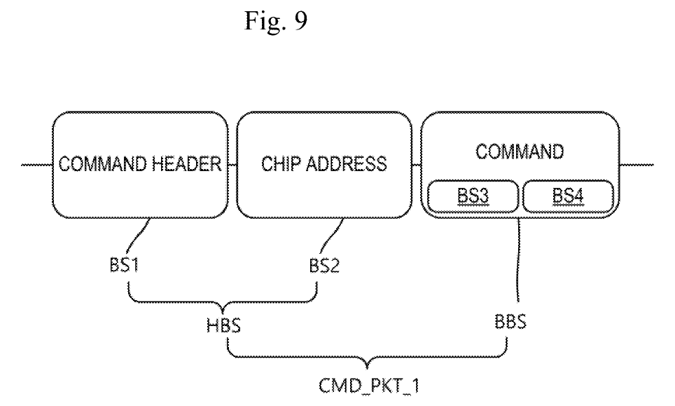

FIG. 9 is a diagram describing a configuration of a command address packet CMD_PKT_1 according to some implementations of the present disclosure. The command address packet CMD_PKT_1 of FIG. 9 may be transmitted from the processor 110 of FIG. 1 to the non-volatile memory device 120 based on the timing diagram of FIG. 2.

The command address packet CMD_PKT_1 according to some implementations of the present disclosure will be described with reference to FIGS. 1, 2. and 9.

The header bit signal HBS of the command address packet CMD_PKT_1 according to the implementations of FIG. 9 may include the command header and the chip address. The body bit signal BBS may include a command. The processor 110 of FIG. 1 may transmit the command address packet CMD_PKT_1, in which the command header and the chip address are encoded in the header bit signal HBS, to the non-volatile memory device 120 through at least three or more pins, and thus, the efficiency of transmission of a command and an address may be improved. For example, the processor 110 may not transmit a separate command address packet for transmitting only the chip address to the non-volatile memory device 120.

The first bit signal BS1 of the command address packet CMD_PKT_1 may include the command header, and the second bit signal BS2 thereof may include the chip address. The first bit signal BS1 may be transmitted at the rising edge of the first cycle of the command address clock signal CA_CLK of FIG. 2, and the second bit signal BS2 may be transmitted at the falling edge of the first cycle of the command address clock signal CA_CLK of FIG. 2.

The third bit signal BS3 and the fourth bit signal BS4 of the command address packet CMD_PKT_1 may include a command and may be transmitted during the second cycle of the command address clock signal CA_CLK of FIG. 2.

In some implementations, when the non-volatile memory chip includes one logical unit number (LUN), the chip address may be the same as an LUN address.

In some implementations, when the non-volatile memory chip includes a plurality of LUNs, the chip address may mean at least any one of LUN addresses of the plurality of LUNs.

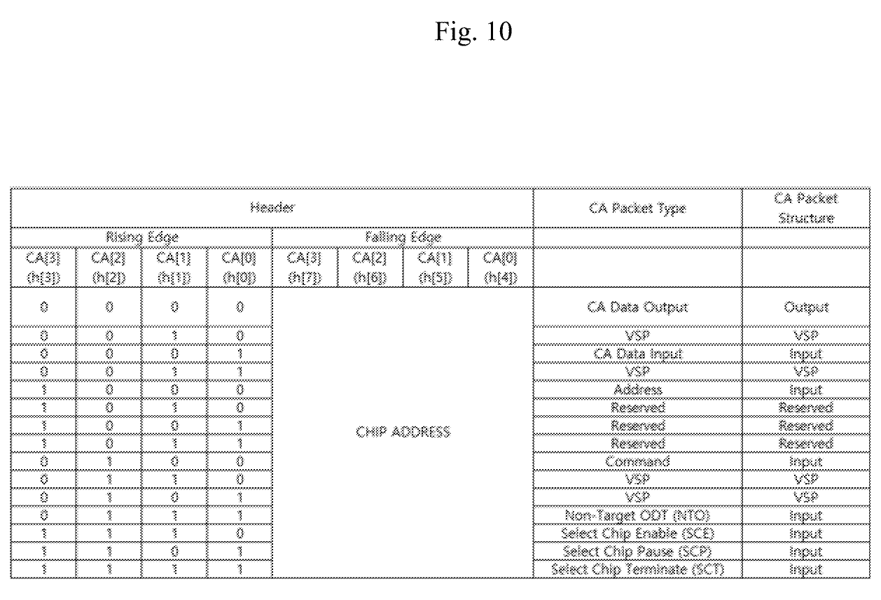

FIG. 10 is a diagram describing a header of the command address packet CMD_PKT_1 according to some implementations of the present disclosure.

Referring to FIG. 10, the first bit signal BS1 of FIG. 9 may be encoded based on four bits h[3:0] of the header, and the second bit signal BS2 of FIG. 9 may be encoded based on four bits h[7:4] of the header. The four bits h[7:4] of the header may include the chip address.

Unlike the types of the command address packet of the related art according to FIG. 4, types of the command address packet according to the implementations of FIG. 10 may not define an LUN selection packet LUNSel.

For example, based on the definition of the types of the command address packet according to the implementations of FIG. 10, the processor 110 of FIG. 1 may not separately transmit the LUN selection packet LUNSel to the non-volatile memory device 120. The processor 110 may transmit chip selection information (chip address) and the command together through the command packet among the types of the command address packet according to the implementations of FIG. 10.

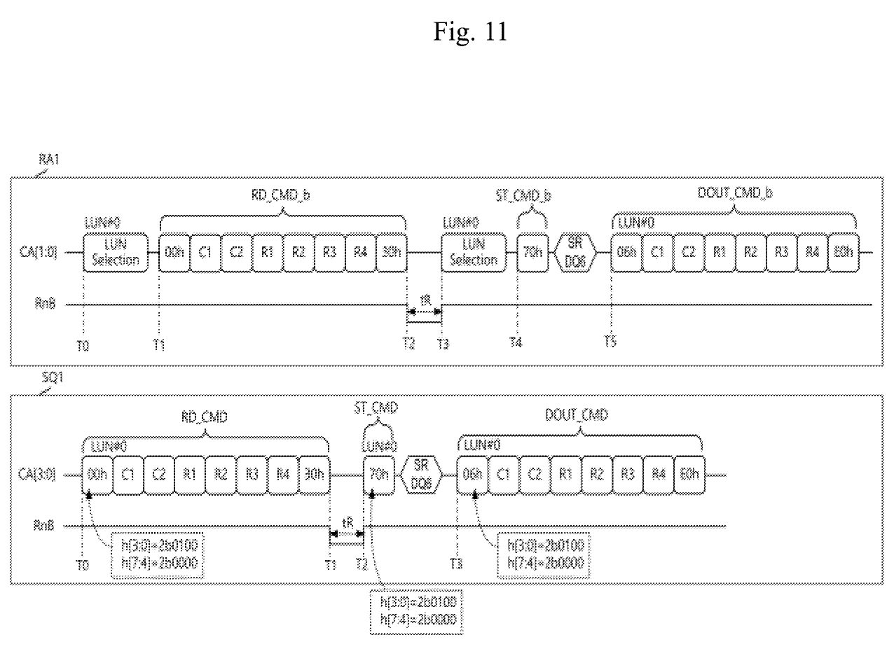

FIG. 11 is a diagram describing read sequences according to the implementations of FIG. 9.

Referring to FIG. 11, a processor according to the related art may transmit read sequences RA1 to a non-volatile memory device. The read sequences RA1 includes a read command sequence RD_CMD_b, a status command sequence ST_CMD_b, a data output command sequence DOUT_CMD_b, and an LUN selection sequence LUN Selection.

In contrast, the processor 110 of FIG. 1 according to some implementations of the present disclosure may transmit read sequences SQ1 to the non-volatile memory device 120. The read sequences SQ1 includes a read command sequence RD_CMD, a status command sequence ST_CMD, and a data output command sequence DOUT_CMD.

Unlike the read sequences RA1 according to the related art, the read sequences SQ1 according to the implementations of FIG. 11 do not include the LUN selection sequence LUN Selection. The chip address (LUN selection information or LUN address) may be included in the command packets.

For example, in the command packet of the read command sequence RD_CMD, the four bits h[7:4] of the header bit signal HBS may include the LUN address whose binary bit values are “0000” indicating a first LUN. In the command packet of the read command sequence RD_CMD, the four bits h[3:0] of the header bit signal HBS may include binary bit values of “0100” defining the command packet of FIG. 10.

Likewise, in the command packet of the status command sequence ST_CMD and the command packet of the data output command sequence DOUT_CMD, the header bit signal HBS may include binary bit values of “0100” defining the command packet and the LUN address whose binary bit values are “0000” indicating a first LUN.

FIG. 11 shows the read sequences as an example, but as in the above description, a header bit signal of a command packet of a program sequence may also include a chip address and a command header defining a command packet.

FIG. 11 shows the command packet indicating the first LUN as an example, but when the non-volatile memory device includes a plurality of memory chips, each command packet may include a chip address differently set depending on a receiver. For example, the header of the command packet of a first read command sequence may include an LUN address of a first LUN, and the header of the command packet of a second read command sequence may include an LUN address of a second LUN.

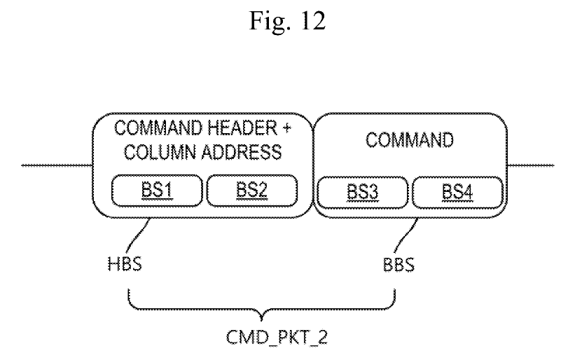

FIG. 12 is a diagram describing a configuration of a command address packet CMD_PKT_2 according to some implementations of the present disclosure. The command address packet CMD_PKT_2 of FIG. 12 may be transmitted from the processor 110 of FIG. 1 to the non-volatile memory device 120 based on the timing diagram of FIG. 2.

The command address packet CMD_PKT_2 according to some implementations of the present disclosure will be described with reference to FIGS. 1, 2, and 12. Additional description which is the same as the description given based on the command address packet CMD_PKT_1 of FIG. 9 will be omitted to avoid redundancy.

The header bit signal HBS of the command address packet CMD_PKT_2 according to the implementations of FIG. 12 may include the merged command header and the column address. The body bit signal BBS may include a command. The processor 110 of FIG. 1 may transmit the command address packet CMD_PKT_2, in which the command header and the column address are encoded in the header bit signal HBS, to the non-volatile memory device 120 through at least three or more pins, and thus, the efficiency of transmission of a command and an address may be improved. For example, the processor 110 may not transmit a separate command address packet for transmitting only the column address to the non-volatile memory device 120.

The first bit signal BS1 and the second bit signal BS2 of the command address packet CMD_PKT_2 may include the merged command header and the column address. As the header bit signal HBS, the merged command header and the column address may be transmitted during the first cycle of the command address clock signal CA_CLK of FIG. 2. The body bit signal BBS may be transmitted during the second cycle of the command address clock signal CA_CLK. The body bit signal BBS may include a command.

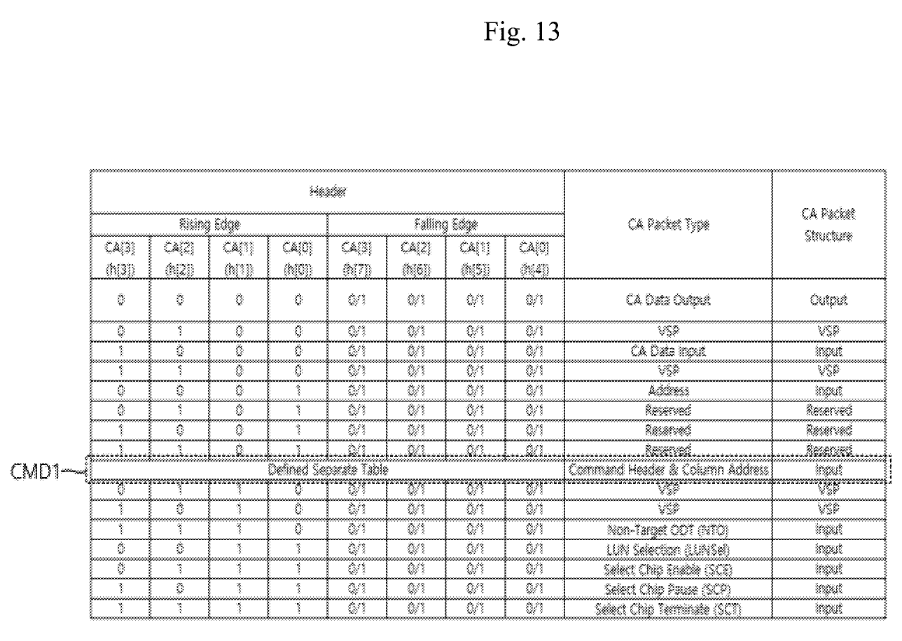

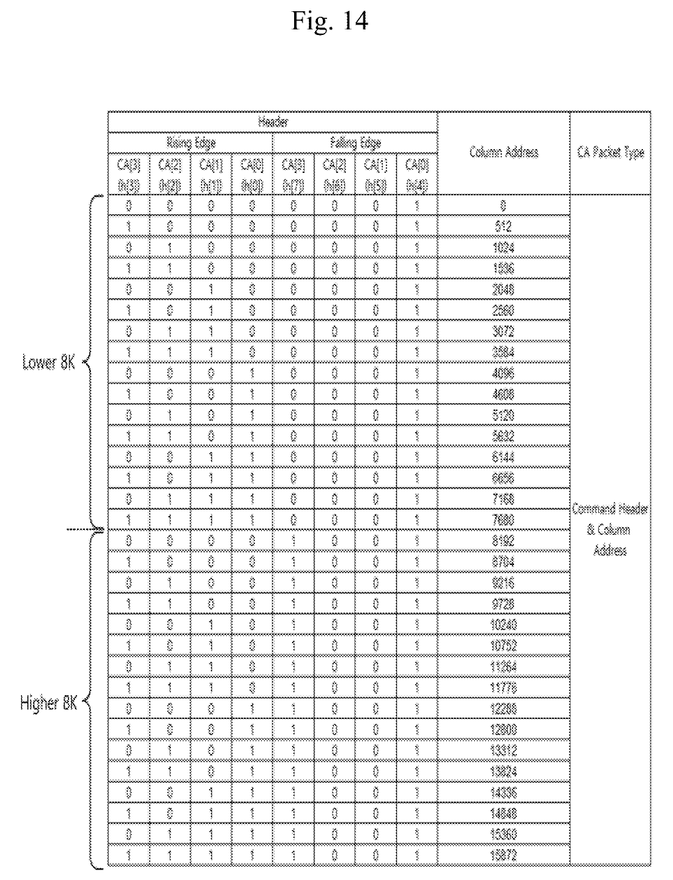

FIGS. 13 and 14 are diagrams describing a header of the command address packet CMD_PKT_2 according to the implementations of FIG. 12.

Referring to FIG. 13, except for a first command packet CMD1 defining the merged command header and the column address, the header bit signal h[3:0] of each of the remaining packets may be defined to be the same as the header bit signal h[3:0] of FIG. 4. The header bit signal h[7:4] of each of the remaining packets may be defined by bit signals each including any one of a binary bit value “0” and a binary bit value “1”. For example, the header bit signal h[7:4] of each of the remaining packets may be defined as a binary bit value of “0000” or may be defined as a binary bit value of “1111”.

Referring to FIG. 13, the header bit signal h[7:0] of the first command packet CMD1 defining the merged command header and the column address may be encoded differently based on the column address as illustrated in FIG. 14.

Referring to FIG. 14, the header bit signal h[3:0] of the first command packet CMD1 may define the first bit signal BS1 of FIG. 2 and may include bit signals which are differently set every preset range of the column address.

For example, FIG. 14 shows that the header bit signal h[3:0] of the first command packet CMD1 is defined by bit values which are differently set every 512 bytes of the column address.

In some implementations, unlike the implementations of FIG. 14, the header bit signal h[7:4] of the first command packet CMD1 may include bit signals which are differently set every preset range of the column address.

In some implementations, unlike the implementations of FIG. 14, any one of the header bit signal h[3:0] and the header bit signal h[7:4] of the first command packet CMD1 may include bit signals which are differently set every preset range of the column address.

In some implementations, unlike the implementations of FIG. 14, any one of the header bit signal h[3:0] and the header bit signal h[7:4] of the first command packet CMD1 may include bit signals which are differently set every range different from the range of the 512 bytes of the column address.

Referring to FIG. 13, in some implementations, the header bit signal h[7:4] corresponding to column addresses of 8K lower bytes of the page may be identical to each other, and the header bit signal h[7:4] corresponding to column addresses of 8K higher bytes of the page may be identical to each other.

When the header bit signal of the received packet includes the bit values of the header bit signal h[7:0] defined in FIG. 14, the non-volatile memory device 120 of FIG. 1 may determine that the received packet is the command packet and may decode the command from the body bit signal. Also, the non-volatile memory device 120 may decode the corresponding column address from the header bit signal h[7:0] of the received packet, based on the definition of FIG. 14.

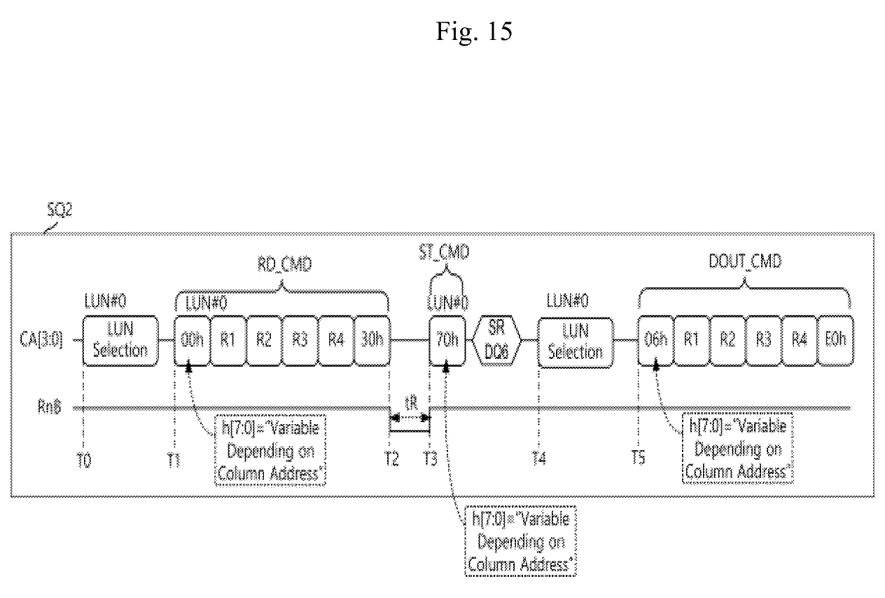

FIG. 15 is a diagram describing read sequences according to the implementations of FIG. 12.

Referring to FIG. 15, the processor 110 of FIG. 1 may transmit read sequences SQ2 to the non-volatile memory device 120. The read sequences SQ2 includes the read command sequence RD_CMD, the status command sequence ST_CMD, and the data output command sequence DOUT_CMD.

Each of command packets of the read sequences SQ1 according to the implementations of FIG. 11 may include the header bit signal h[7:0] described with reference to FIGS. 13 and 14. The header bit signal h[7:0] may be in the form of merging the command header and the column address. The header bit signal h[7:0] may be implemented with bit signals whose values vary every preset range of the column address.

Unlike the read command sequence RD_CMD_b and the data output command sequence DOUT_CMD_b of the read sequences RA1 of the related art described with reference to FIG. 11, the read command sequence RD_CMD and the data output command sequence DOUT_CMD of the read sequences SQ1 according to the implementations of FIG. 11 do not include the column address packets C1 and C2. The column address packets C1 and C2 are packets where the column address is included in the body bit signal.

Accordingly, in the read sequences SQ1 according to the implementations of FIG. 11, as the head bit signal of the command packet includes the column address, the processor 110 of FIG. 1 may not transmit the column address packet. Accordingly, the input/output efficiency associated with the transmission of the command address signal may be improved.

Also, like the implementations of FIG. 14, as the header bit signal h[7:0] is implemented with different bit signals every preset range of the column address, pieces of data corresponding to column addresses of the given range may be continuously output. When the given range is set sufficiently small based on an operation size of machine learning, the storage device 100 of FIG. 1 may provide data necessary for the operation of an artificial intelligence accelerator including the machine learning on behalf of at least part of a dynamic random access memory (DRAM).

FIG. 14 shows the read sequences as an example, but as in the above description, a header bit signal of a command packet of a program sequence may also include a column address and a command header defining a command packet.

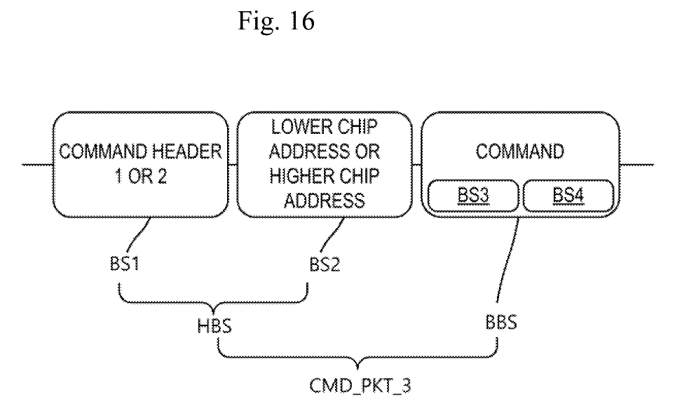

FIG. 16 is a diagram describing a configuration of a command address packet CMD_PKT_3 according to some implementations of the present disclosure. The command address packet CMD_PKT_3 of FIG. 16 may be transmitted from the processor 110 of FIG. 1 to the non-volatile memory device 120 based on the timing diagram of FIG. 2.

The command address packet CMD_PKT_3 according to some implementations of the present disclosure will be described with reference to FIGS. 1, 2, and 16. Additional description which is the same as the description given based on the command address packet CMD_PKT_1 of FIG. 9 and the command address packet CMD_PKT_2 of FIG. 12 will be omitted to omit redundancy.

The header bit signal HBS of the command address packet CMD_PKT_3 according to the implementations of FIG. 16 may include the command header and the chip address. The body bit signal BBS may include a command. The processor 110 of FIG. 1 may transmit the command address packet CMD_PKT_3, in which the command header and the chip address are encoded in the header bit signal HBS, to the non-volatile memory device 120 through at least three or more pins, and thus, the efficiency of transmission of a command and an address may be improved. For example, the processor 110 may not transmit a separate command address packet for transmitting only the chip address to the non-volatile memory device 120. Also, the command address packet CMD_PKT_3 in which the command header and the chip address are encoded may be defined in two types based on the range of the chip address, and thus, the processor 110 may control more chips.

Referring to FIG. 16, except for a second command packet CMD2 and a third command packet CMD3 defining the merged command header and the column address, the header bit signal h[3:0] of each of the remaining packets may be defined to be the same as the header bit signal h[3:0] of FIG. 4. The header bit signal h[7:4] of each of the remaining packets may be defined in the form where the header bit signal h[3:0] is repeated.

The first bit signal BS1 of the command address packet CMD_PKT_3 may include the command header, and the second bit signal BS2 thereof may include the chip address. The first bit signal BS1 may be transmitted at the rising edge of the first cycle of the command address clock signal CA_CLK of FIG. 2, and the second bit signal BS2 may be transmitted at the falling edge of the first cycle of the command address clock signal CA_CLK of FIG. 2. The body bit signal BBS may include a command.

Unlike the command address packet CMD_PKT_1 described with reference to FIG. 9, the first bit signal BS1 of the command address packet CMD_PKT_3 according to the implementations of FIG. 16 may be defined in two types.

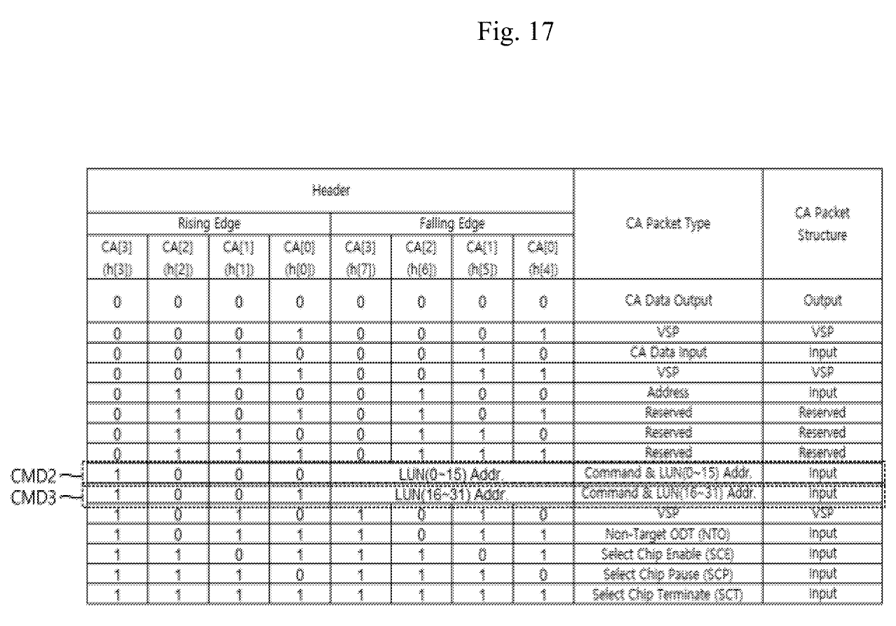

For example, FIG. 17 is a diagram describing a header of a command address packet according to some implementations.

Referring to FIG. 17, the first bit signal BS1 of the second command packet CMD2 including an LUN address of each of LUNs belonging to the first group may include the header bit signal h[3:0] whose binary bit values are “1000”, and the first bit signal BS1 of the third command packet CMD3 including an LUN address of each of LUNs belonging to the second group may include the header bit signal h[3:0] whose binary bit values are “1001”. In the two cases, the second bit signal BS2 may include the header bit signal h[7:4] whose bit value indicates an LUN address of any one LUN among 16 LUNs.

The non-volatile memory device 120 of FIG. 1 may determine LUNs belonging to any one group from among a plurality of LUNs as a receiver of the command packet, based on the first bit signal BS1. The non-volatile memory device 120 may determine any one LUN among LUNs of a group determined based on the second bit signal BS2, as a receiver of the command packet.

Accordingly, in addition to the effect of the command address packet CMD_PKT_1 described with reference to FIG. 9, the command address packet CMD_PKT_3 according to the implementations of FIGS. 16 and 17 may be used in a storage device including more LUNs.

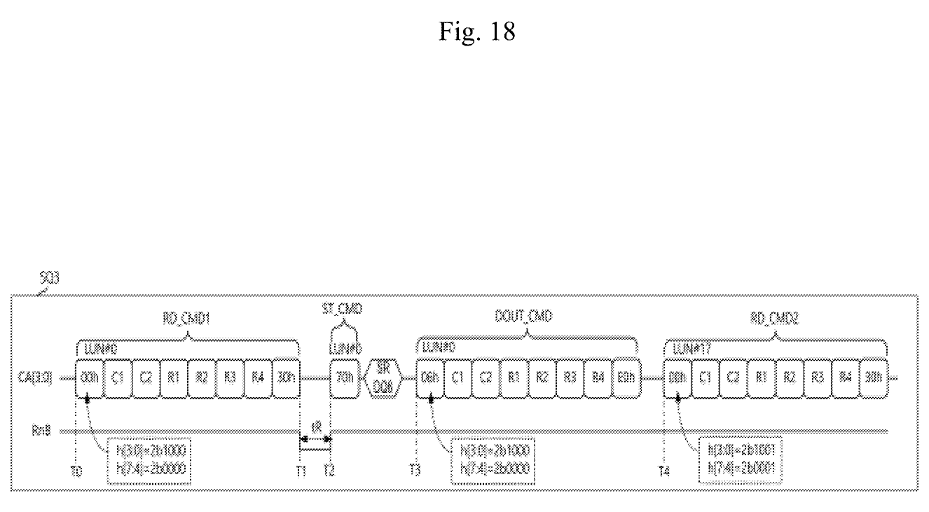

FIG. 18 is a diagram describing read sequences according to the implementations of FIG. 16.

Unlike the command sequences of the command address packet CMD_PKT_1 described with reference to FIG. 9, in each of read sequences RD_CMD1, RD_CMD2, ST_CMD, and DOUT_CMD according to the implementations of FIG. 18, the header bit signal h[3:0] is defined differently for each group of FIG. 17.

For example, the header bit signal h[3:0] of the first read command sequence RD_CMD1 may be defined as binary bit values of “1000” corresponding to a group to which a first LUN LUN#0 (corresponding to an LUN address whose binary bit values are “0000”) belongs. The header bit signal h[3:0] of the second read command sequence RD_CMD2 may be defined as binary bit values of “1001” corresponding to a group to which an 18th LUN LUN#17 (corresponding to an LUN address whose binary bit values are “0001”) belongs.

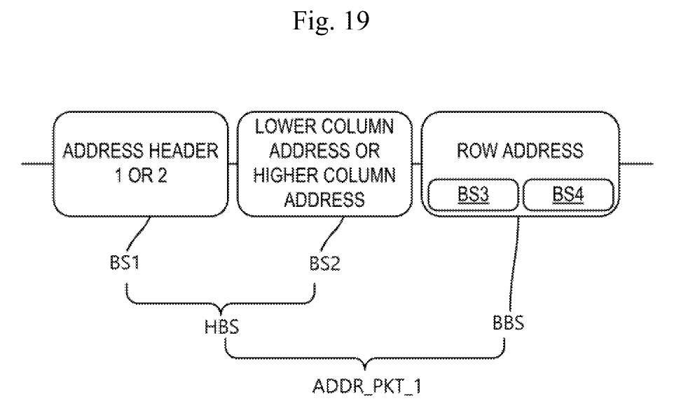

FIG. 19 is a diagram describing a configuration of a command address packet ADDR_PKT_1 according to some implementations of the present disclosure. The command address packet ADDR_PKT_1 of FIG. 19 may be transmitted from the processor 110 of FIG. 1 to the non-volatile memory device 120 based on the timing diagram of FIG. 2.

The command address packet ADDR_PKT_1 according to some implementations of the present disclosure will be described with reference to FIGS. 1, 2, and 19. Additional description which is the same as the descriptions given based on the command address packet CMD_PKT_1 of FIG. 9, the command address packet CMD_PKT_2 of FIG. 12, and the command address packet CMD_PKT_3 of FIG. 16 will be omitted to omit redundancy.

The header bit signal HBS of the command address packet ADDR_PKT_1 according to the implementations of FIG. 19 may include the address header and the column address. The body bit signal BBS may include the row address. The processor 110 of FIG. 1 may transmit the command address packet ADDR_PKT_1, in which the address header and the column address are encoded in the header bit signal HBS, to the non-volatile memory device 120 through at least three or more pins, and thus, the efficiency of transmission of a command and an address may be improved. For example, the processor 110 may not transmit a separate command address packet for transmitting only the column address to the non-volatile memory device 120. Also, the command address packet ADDR_PKT_1 may be defined in two types based on a range of a bit column address of the header bit signal HBS. Accordingly the non-volatile memory device 120 may quickly determine the column address targeted for an access, based on the header bit signal h[3:0].

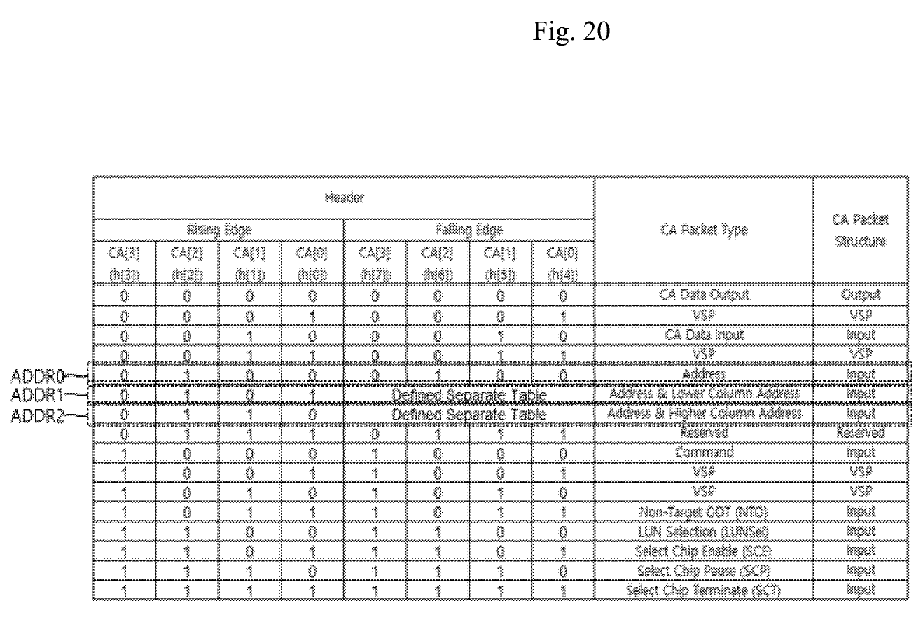

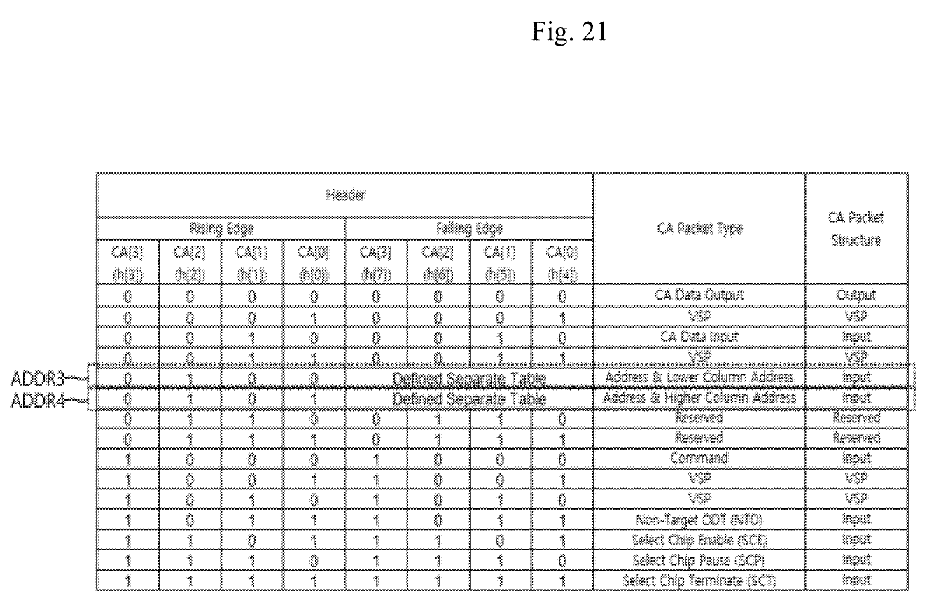

Referring to FIG. 20, except for a first address packet ADDR1 and a second address packet ADDR2 defining the address header and the column address, the header bit signal h[3:0] of each of the remaining packets may be defined to be the same as the header bit signal h[3:0] of FIG. 4. The header bit signal h[7:4] of each of the remaining packets may be defined in the form where the header bit signal h[3:0] is repeated.

The first bit signal BS1 of the command address packet ADDR_PKT_1 may include the address header, and the second bit signal BS2 thereof may include the column address. The first bit signal BS1 may be transmitted at the rising edge of the first cycle of the command address clock signal CA_CLK of FIG. 2, and the second bit signal BS2 may be transmitted at the falling edge of the first cycle of the command address clock signal CA_CLK of FIG. 2. The body bit signal BBS may include the row address.

The first bit signal BS1 of the command address packet ADDR_PKT_1 according to the implementations of FIG. 19 may be defined in two types.

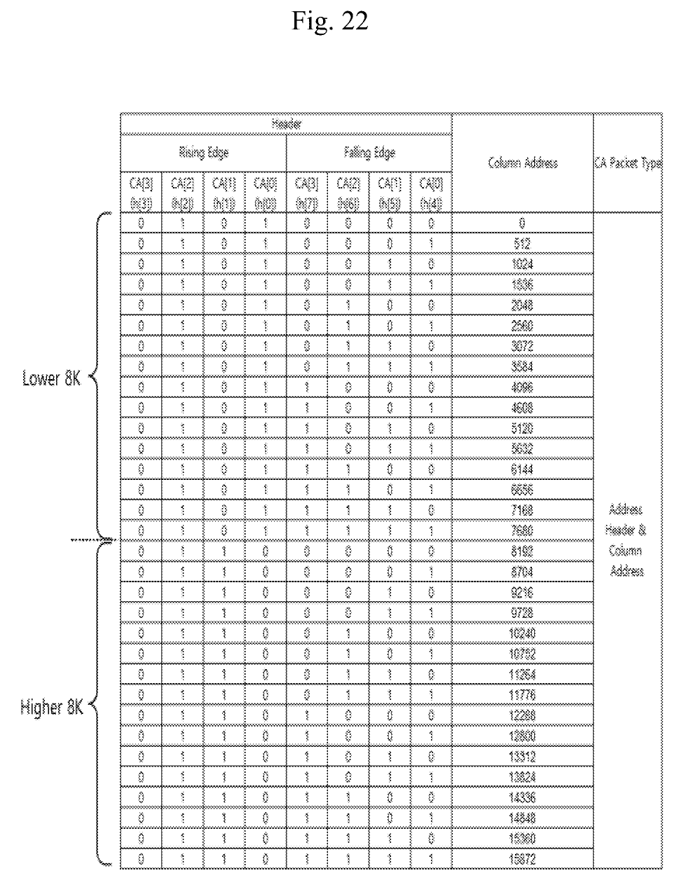

Referring to FIGS. 20 and 22, in some implementations, the header bit signal h[3:0] corresponding to column addresses of a first sub-page of the page, which is associated with 8K lower bytes, may have the same binary bit value, for example, “0101”, and the header bit signal h[3:0] corresponding to column addresses of a second sub-page of the page, which is associated with 8K higher bytes, may have the same binary bit value, for example, “0110”.

Based on the first bit signal BS1 of the command address packet ADDR_PKT_1, the non-volatile memory device 120 of FIG. 1 may sense data of any one of the first sub-page and the second sub-page or may determine any one of the first sub-page and the second sub-page as a sub-page to be programmed. Based on the second bit signal BS2, the non-volatile memory device 120 may sense data from the determined sub-page or may determine a column address to be programmed.

Referring to FIG. 22, the header bit signal h[7:4] of the first address packet ADDR1 and the second address packet ADDR2 may be differently encoded based on the column address.

In some implementations, like the implementations of FIG. 22, the header bit signal h[7:4] of each of the first address packet ADDR1 and the second address packet ADDR2 may include bit signals which are differently set every preset range of the column address. For example, FIG. 22 shows that the header bit signal h[3:0] of each of the first address packet ADDR1 and the second address packet ADDR2 is defined by bit values which are differently set every 512 bytes of the column address.

In some implementations, unlike the implementations of FIG. 22, any one of the header bit signal h[3:0] and the header bit signal h[7:4] of each of the first address packet ADDR1 and the second address packet ADDR2 may include bit signals which are differently set every preset range of the column address.

In some implementations, unlike the implementations of FIG. 14, any one of the header bit signal h[3:0] and the header bit signal h[7:4] of each of the first address packet ADDR1 and the second address packet ADDR2 may include bit signals which are differently set every range different from the range of the 512 bytes of the column address.

In some implementations, referring to FIG. 20, in addition to the first address packet ADDR1 and the second address packet ADDR2, an address packet ADDR0 is separately defined. Unlike the first address packet ADDR1 and the second address packet ADDR2, the address packet ADDR0 may not include the column address. The processor 110 of FIG. 1 may selectively use the address packet ADDR0, the first address packet ADDR1, and the second address packet ADDR2.

FIG. 20 defines the LUN selection packet LUNSel, but in some implementations, when the command address packet ADDR_PKT_1 is used together with the command address packet CMD_PKT_3 of FIG. 16, the definition of the LUN selection packet LUNSel of FIG. 20 may not be used.

FIG. 21 is a diagram describing another header of the command address packet ADDR_PKT_1 according to the implementations of FIG. 19.

Unlike the header of the command address packet ADDR_PKT_1 according to the implementations of FIG. 20, the header of the command address packet ADDR_PKT_1 according to the implementations of FIG. 21 does not define the address packet ADDR0 which does not include the column address. Bit values of the header bit signal h[3:0] of the command address packet ADDR_PKT_1 according to the implementations of FIG. 20 may be defined to be different from the bit values of FIG. 22. For example, the header bit signal h[3:0] corresponding to column addresses of the first sub-page of the page, which is associated with 8K lower bytes, may have the same binary bit value, for example, “0100”, and the header bit signal h[3:0] corresponding to column addresses of the second sub-page of the page, which is associated with 8K higher bytes, may have the same binary bit value, for example, “0101”.

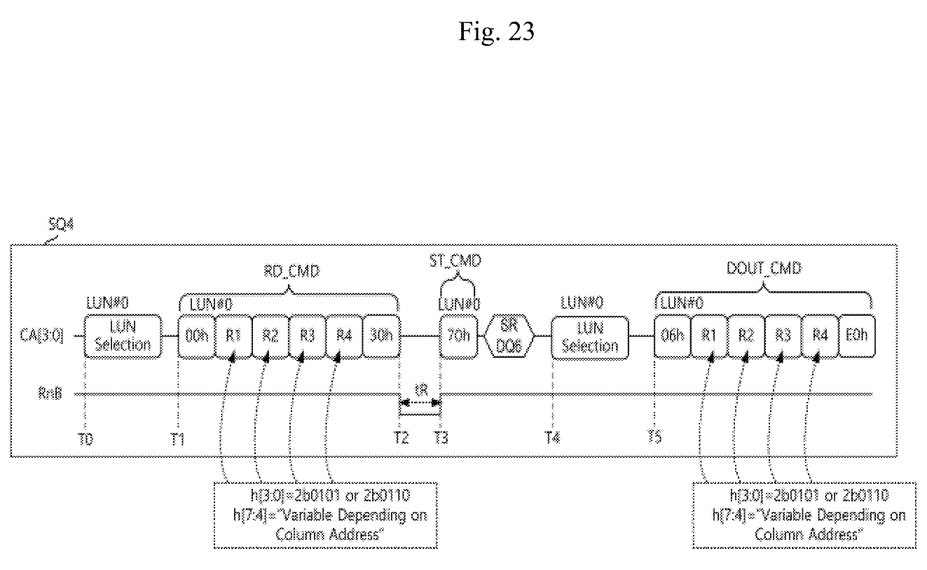

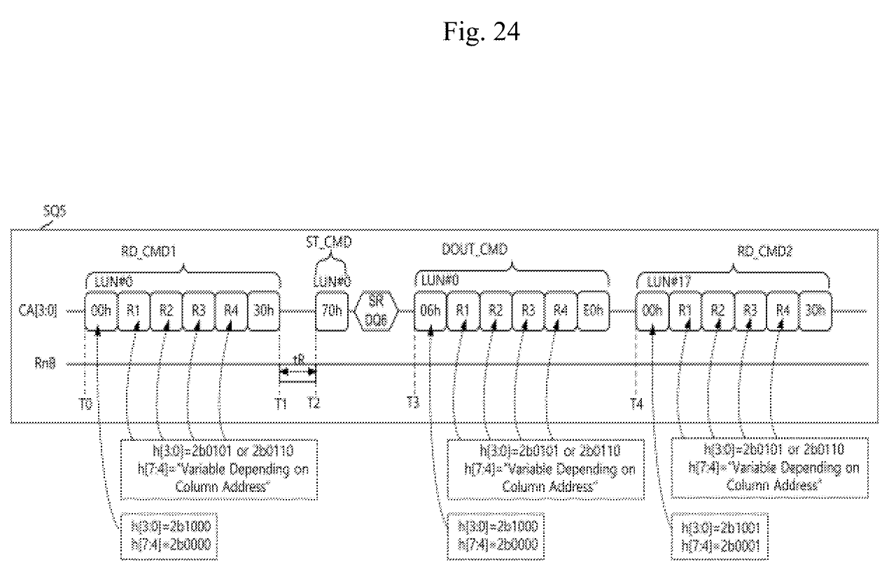

FIGS. 23 and 24 are diagrams describing read sequences according to the implementations of FIG. 19.

In read sequences SQ4 according to the implementations of FIG. 23, each of the command sequences RD_CMD and DOUT_CMD do not include the column address packets C1 and C2 of the read sequences RA1 according to the related art of FIG. 11. The column address packets C1 and C2 are column address packets where the column address is included in the body bit signal.

Accordingly, in the read sequences SQ4 according to the implementations of FIG. 23, because the header bit signal of the address packet (command address packet where the row address is included in the body bit signal) includes the column address, the processor 110 of FIG. 1 may not separately transmit the column address packet (column address packet where the column address is included in the body bit signal). Accordingly, the input/output efficiency associated with the transmission of the command address signal may be improved.

In some implementations, in read sequences according to the implementations of FIG. 23, the header bit signal h[7:0] of each of the command sequences RD_CMD and DOUT_CMD may be based on any one of FIGS. 20 and 21.

In read sequences SQ5 according to the implementations of FIG. 24, each of the command sequences RD_CMD and DOUT_CMD do not include the column address packet like the read sequences SQ4 according to the implementations of FIG. 23. Like the read sequences SQ4 according to the implementations of FIG. 23, the header bit signal of the address packet of each of the read sequences SQ5 may include the column address.

Also, the command address packet CMD_PKT_3 according to the implementations of FIG. 16 may be used as the command packet (the command address packet where the command is included in the body bit signal) of each of the command sequences RD_CMD and DOUT_CMD of the read sequences SQ5.

Accordingly, unlike the read sequences SQ4 according to the implementations of FIG. 23, the read sequences SQ5 according to the implementations of FIG. 24 may not include the LUN selection packet (command address packet where the chip address is included in the body bit signal). The header bit signal of the command packet of each of the command sequences RD_CMD and DOUT_CMD of the read sequences SQ5 may include the LUN address.

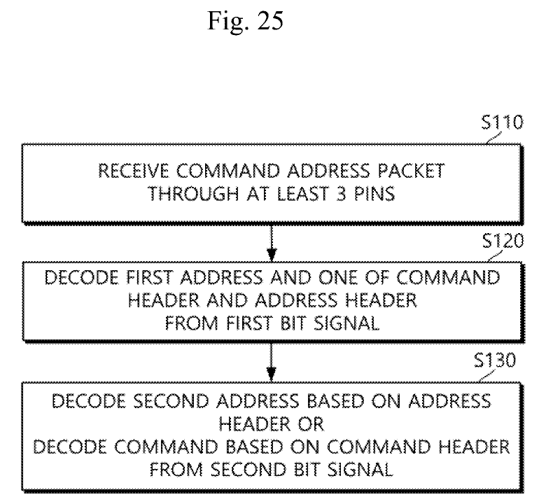

FIG. 25 is a flowchart describing an operation method of a non-volatile memory device according to some implementations of the present disclosure.

Descriptions which are the same as the descriptions given with reference the implementations of FIGS. 1 to 24 will be omitted, and the operation method of the non-volatile memory device will be described. The operation method of FIG. 25 may be performed by the non-volatile memory device 120 of FIG. 1.

In operation S110, through at least three pins, an input/output circuit of the non-volatile memory device 120 may receive the command address packet in the first cycle and the second cycle of the command address clock signal, which are consecutive in that the second cycle follows immediately after the first cycle with no intervening command address clock signal cycles.

In operation S120, a control logic circuit of the non-volatile memory device 120 may decode any one of the command header and the address header and the first address from the first bit signal received in the first cycle.

In operation S130, the control logic circuit of the non-volatile memory device 120 may decode the command from the second bit signal received in the second cycle, based on the command header. Alternatively, the control logic circuit may decode the second address from the second bit signal received in the second cycle, based on the address header.

In some implementations, the control logic circuit may decode the command header and the chip address based on the first bit signal and may decode the command based on the second bit signal.

In some implementations, the control logic circuit may decode the command header and the column address based on the first bit signal and may decode the command based on the second bit signal.

In some implementations, like the implementations of FIG. 2, the input/output circuit may receive the third bit signal at the rising edge of the second cycle and may receive the fourth bit signal at the falling edge of the second cycle. The control logic circuit may determine a non-volatile memory chip group designated as a receiver of the command packet based on the fourth bit signal and may determine a non-volatile memory chip group designated as a receiver of the command packet based on the fourth bit signal.

In some implementations, the control logic circuit may decode the address header and the column address based on the first bit signal and the row address based on the second bit signal.

In the implementations of the present disclosure, the bit values of the header bit signal are provided as an implementation example and are capable of being implemented with other bit values. For example, the bit values of the header bit signals of FIGS. 10, 13, 14, 17, 20, 21, and 22 may be implemented by replacing the bit values with other bit values.

According to implementations of the present disclosure, a non-volatile memory device, an operation method of the non-volatile memory device, and a storage device including the non-volatile memory device may improve the efficiency of input/output between a processor and the non-volatile memory device.

According to implementations of the present disclosure, a non-volatile memory device, an operation method of the non-volatile memory device, and a storage device including the non-volatile memory device may improve the efficiency of input/output of a command and an address between a processor and the non-volatile memory device.

While this specification contains many specific implementation details, these should not be construed as limitations on the scope of any disclosure or on the scope of what may be claimed, but rather as descriptions of features that may be specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A storage device comprising:
a processor configured to transmit a command and an address to a non-volatile memory device through a first bus and to transmit or receive data to or from the non-volatile memory device through a second bus,
wherein the non-volatile memory device is configured to sense data from a non-volatile memory cell based on the command and the address, and
wherein the processor is configured to transmit any of a command header, an address header, and a first address through at least three first pins, in one cycle of a command address clock signal.

2. The storage device of claim 1, wherein the non-volatile memory device is configured to receive a signal identifying a generation of a separate command address protocol through a plurality of second pins.

3. The storage device of claim 1, wherein the processor is configured to transmit the command header and the first address in one cycle of the command address clock signal, and
wherein the first address includes a chip address.

4. The storage device of claim 3, wherein the processor is configured to:
transmit the command header at a rising edge of a first cycle of the command address clock signal; and
transmit the chip address at a falling edge of the first cycle of the command address clock signal.

5. The storage device of claim 1, wherein the processor is configured to transmit a read command sequence and a program command sequence to the non-volatile memory device, and
wherein each of the read command sequence and the program command sequence includes a command packet and an address packet, and
wherein the command packet includes any of a chip address and a column address.

6. The storage device of claim 1, wherein the processor is configured to transmit a read command sequence and a program command sequence to the non-volatile memory device,
wherein each of the read command sequence and the program command sequence includes a command packet and an address packet, and
wherein the address packet includes a row address and a column address in one package.

7. The storage device of claim 1, wherein the processor is configured to:
transmit the command header and the first address in a first cycle of the command address clock signal; and
transmit a command in a second cycle of the command address clock signal, and
wherein the first address includes a column address.

8. The storage device of claim 7, wherein
the processor is configured to:
transmit a first bit signal in the first cycle of the command address clock signal; and
transmit a second bit signal in the second cycle of the command address clock signal, and
wherein any of the first bit signal and the second bit signal is implemented with bit signals differently set every preset range of the column address.

9. The storage device of claim 1, wherein the processor is configured to:
transmit a first bit signal in a first cycle of the command address clock signal; and
transmit a second bit signal in a second cycle of the command address clock signal,
wherein the first bit signal corresponds to the command header and the first address,
wherein the second bit signal corresponds to a command,
wherein the first address includes a chip address, and
wherein the first bit signal is implemented with a bit signal whose value is differently set every chip address.

10. The storage device of claim 9, wherein the non-volatile memory device includes a first group of non-volatile memory chips and a second group of non-volatile memory chips, and
wherein the processor is configured to:
transmit a third bit signal at a rising edge of the first cycle and transmit a fourth bit signal at a falling edge of the first cycle; and
determine, based on the third bit signal, that one of the first group of non-volatile memory chips and the second group of non-volatile memory chips is a receiver of a command packet.

11. The storage device of claim 10, wherein the processor is configured to:
determine, based on the fourth bit signal, that one of the non-volatile memory chips belonging to the determined one of the first group and the second group as the receiver of the command packet is a final receiver of the command packet.

12. The storage device of claim 1, wherein the processor is configured to:
transmit a first bit signal in a first cycle of the command address clock signal; and
transmit a second bit signal in a second cycle of the command address clock signal,
wherein the first bit signal corresponds to the address header and the first address,
wherein the second bit signal corresponds to a row address,
wherein the first address includes a column address, and
wherein the first bit signal is implemented with a bit signal whose value is differently set every preset range of the column address.

13. The storage device of claim 12, wherein the non-volatile memory device includes a page,
wherein the page includes a first sub-page corresponding to a first column address range and a second sub-page corresponding to a second column address range,
wherein the processor is configured to:
transmit a third bit signal at a rising edge of the first cycle; and
transmit a fourth bit signal at a falling edge of the first cycle, and
wherein the non-volatile memory device is configured to,
sense, based on the third bit signal, data from any sub-page among the first sub-page and the second sub-page or program data in any sub-page among the first sub-page and the second sub-page.

14. The storage device of claim 13, wherein the non-volatile memory device is configured to sense, based on the fourth bit signal, the data in a first column address range of the sub-page or program the data in the first column address range of the sub-page.

15. A non-volatile memory device comprising:
a memory cell array including non-volatile memory cells;
an input/output circuit configured to receive a command and an address through a first bus and to transmit read data through a second bus or receive programming data through the second bus; and
a control logic circuit configured to decode the command,
wherein the input/output circuit is configured to receive any of a command header, an address header, and a first address through at least three first pins, in one cycle of a command address clock signal.

16. An operation method of a non-volatile memory device, the method comprising:
receiving, at an input/output circuit, a command address packet in a first cycle and a second cycle of a command address clock signal, wherein the second cycle is consecutive with the first cycle, through at least three pins;
decoding, at a control logic circuit, any of a command header, an address header, and a first address from a first bit signal received in the first cycle; and
decoding, at the control logic circuit, a command based on the command header or a second address based on the address header, from a second bit signal received in the second cycle.

17. The method of claim 16, comprising:
decoding, at the control logic circuit, the command header and a chip address, based on the first bit signal; and
decoding, at the control logic circuit, the command based on the second bit signal.

18. The method of claim 16, comprising:
decoding, at the control logic circuit, the command header and a column address, based on the first bit signal; and
decoding, at the control logic circuit, the command based on the second bit signal.

19. The method of claim 16, comprising:
receiving, at the input/output circuit, a third bit signal at a rising edge of the first cycle and receiving a fourth bit signal at a falling edge of the first cycle receiving;
determining, at the control logic circuit, a non-volatile memory chip group designated as a receiver of a command packet, based on the third bit signal; and
determining, at the control logic circuit, a non-volatile memory chip group designated as a receiver of the command packet, based on the fourth bit signal,
wherein the non-volatile memory device includes a plurality of non-volatile memory chip groups, and
wherein each of the plurality of non-volatile memory chip groups includes a plurality of non-volatile memory chips.

20. The method of claim 16, comprising:
decoding, at the control logic circuit, the address header and a column address, from the first bit signal; and
decoding, at the control logic circuit, a row address from the second bit signal.
